(19) United States
(12) Patent Application Publication
(10) Pub. No.: US 2025/0010914 A1
(43) Pub. Date: Jan. 9, 2025

(54) TRAIN OF VEHICLES AND STEERING CONTROL SYSTEM FOR SUCH A TRAIN

(71) Applicant: LOHR INDUSTRIE, Hangenbieten (FR)

(72) Inventors: Mike Gatou, Strasbourg (FR); Nicolas Sutter, Strasbourg (FR)

(21) Appl. No.: 18/711,354

(22) PCT Filed: Dec. 6, 2022
(86) PCT No.: PCT/EP2022/084674

§ 371 Date: May 17, 2024

(30) Foreign Application Priority Data
Dec. 7, 2021 (FR) FR2113045

(51) Int. Cl. B62D 12/02; B60D 1/48; B60D 1/62; B62D 6/00

(52) U.S. Cl. CPC B62D 12/02; B60D 1/481; B60D 1/62; B62D 6/001; B62D 6/002

(57) ABSTRACT

A motorized road train includes a lead vehicle and at least one follower vehicle which are hitched to one another, and a CAN communication link linking the vehicles in the train. Each of the vehicles includes a rear axle, a front, steering axle, and electric steering control system including a steering rack, an actuator which acts on the angular orientation of the front, steering axle and a controller which drives the actuator. The controllers of the vehicles are parameterized to generate angular orientation instructions for the front, steering axle of the or each follower vehicle. Each of the vehicles is equipped both with an orientation sensor for determining the angle of the wheels of the front, steering axle and with an angular hitching sensor for determining the yaw angular orientation of the hitch relative to the chassis of the vehicle.

### TECHNICAL FIELD

The present invention relates to the general technical field of the public transport of people and more specifically, to a road train of modular vehicles being able to be used individually, each as an individual vehicle or in a train of several hitched vehicles. Such a train comprises, for example, two, three or four hitched vehicles.

In train mode, the passengers are transported in the seated or standing position and the train is driven by one single driver in the lead vehicle. The follower vehicles are either vehicles which are identical to the lead vehicle, or vehicles which are similar to the lead vehicle, but with no a control station.

The vehicles each comprise, in particular, an electric and/or thermal motorisation, a rear axle, a front steering axle, a braking system, an assisted steering system and a computer to control the functionalities of the vehicles, depending on the operating or safety instructions coming from the driver or from the computer.

Each vehicle also comprises hitching means. These comprise, at the front of the vehicle, a retractable hitching drawbar and at the rear, a hitch clevis. Thus, the hitching drawbar of a follower vehicle has a free end locked in the hitch clevis of the follower vehicle preceding it, or of the lead vehicle and an articulation end articulated under the vehicle.

When the road train is formed, the only degrees of freedom authorised between the towing vehicle and the follower vehicle are provided on the one hand, by a pivot link about a transverse axis located at the rear of the towing vehicle (pivot link of the hitch clevis on the chassis) and on the other hand, by a ball link or hitching pivot about a point located in the vicinity of the front axle of the follower vehicle.

In order to be able to be integrated in traffic, such a road train must be single-track, i.e. that the follower vehicles of the road train must fall into the trajectory of the lead vehicle also called towing vehicle.

The train must, moreover, be stable, in a straight line and curved, in particular, in a yaw.

### BACKGROUND

A vehicle being able to form a train is known, for example, by way of document WO 98/40263. The vehicle described comprises, in particular, a position sensor of the steering wheel, force sensors to detect lateral forces exerted at the articulation between the hitched vehicles and a controller. The latter, at the input, receives the data from the position and force sensors, and at the output, instructions to control an actuator acting on the orientation of the wheels of a steering axle. The steering axles of the follower vehicles are thus only controlled depending on the lateral forces measured at the coupling.

However, such a solution does not make it possible to measure the relative positions of each kinematic sub-assembly of the train and to precisely deduce the position of the steering axles of the follower vehicles, depending on these relative positions, on the speed of the train and on the angle of the steering wheel of the lead vehicle. The solution presented in this document does not give to the train, neither a sufficient stability, nor a sufficiently single-track behaviour. Furthermore, the solution described in this document is not satisfactory for controlling the steering axles of the follower vehicles of the train when reversing.

### SUMMARY OF THE DISCLOSURE

The aim of the invention consequently aims to overcome the disadvantages of the prior art, by proposing a new controlled, assisted steering system for a road train, making it possible to improve the stability and the single-track behaviour of said train.

The aims assigned to the invention are achieved using the motorised road train comprising a lead vehicle and at least one hitched follower vehicle, as well as a CAN communication link linking the vehicles of the train, each of the vehicles comprising a rear axle and a front steering axle, an electric assisted steering system comprising a steering rack, an actuator acting on the angular orientation of the front steering axle and a controller which drives the actuator, each of the vehicles also comprising hitching members, so that the follower vehicle can be hitched to the lead vehicle or to another follower vehicle, the controllers of the vehicles being configured to generate angular orientation instructions of the front steering axle of the or of each follower vehicle, characterised in that each of the vehicles is equipped both with an orientation sensor for determining the angle of the wheels of the front steering axle and with an angular hitching sensor for determining the yaw angular orientation of the hitch, the controller of the or of each follower vehicle delivering an optimal wheel angle instruction and specific to the actuator of the follower vehicle in question, said optimal and specific angle instruction being defined by using a kinematic control law that is a function of the angle of the wheels of the steering axle of the preceding vehicle and of the yaw angular orientation of the hitch relative to the chassis of the follower vehicle in question, so as to obtain a single-track train.

According to an example of an embodiment, the orientation sensor is an angle sensor of a steering rack and pinion which is located at the output of the steering rack, which measures the angle of the rack and pinion relative to its position in a straight line, said rack and pinion angle for determining, by calculation, the angle of the wheels of the steering axle.

According to an example of an embodiment, the front hitching members comprise a hitching drawbar with one single hitching articulation, located under the vehicle, and the free end of which is angularly locked with the rear hitching members of the preceding vehicle.

According to an example of an embodiment, the hitching articulation is located in a plane transverse to the longitudinal direction of the follower vehicle in question, in the vicinity and preferably to the rear of the front steering axle.

According to an example of an embodiment, the rear hitching members comprise a hitch clevis.

According to an example of an embodiment, at least the lead vehicle comprises a control station equipped with a steering wheel to manually or remotely control the angular orientation of the front steering axle of said lead vehicle.

According to an example of an embodiment, the train comprises a lead vehicle and at least one follower vehicle, said follower vehicle having no control station.

According to another example of an embodiment, the train comprises a lead vehicle and at least one follower vehicle, said lead and follower vehicles having no control station to constitute an autonomous train.

As an example, the motorised road train comprising a lead vehicle and at least one follower vehicle, can also be used in an autonomous train, even if at least one of these vehicles is equipped with a control station.

According to an example of an embodiment, the train comprises two, three or four follower vehicles which are identical to the lead vehicle.

According to an example of an embodiment, the communication link comprises connecting pins, to electrically link the hitched vehicles, and the electric architecture of which makes it possible to identify the position of each vehicle in the train.

According to an example of an embodiment, the or each follower vehicle (2) does not have a control station, the controller, thanks to a passage law deducing by calculating the angle of the rack and pinion of the follower vehicle in question, as an instruction intended for the actuator of the steering rack.

The aims assigned to the invention are also achieved using a method for a steering control system of the front steering axle of a follower vehicle for a single-track motorised road train such as presented above, comprising the steps:
a) determining the angle of the wheels of the front steering axle relative to the chassis of the lead vehicle,
b) measuring the hitching angle of the follower vehicle corresponding to the angular orientation of the hitch relative to the chassis of said follower vehicle,
c) using a mathematical law deduced from a geometric modelling of the train, to determine the optimal angle of the wheels of the front steering axle of the follower vehicle from the angle of the wheels determined in a) and from the hitching angle measured in b), and
d) delivering by way of the controller of the follower vehicle, an instruction to the actuator of the motorised steering of said follower vehicle, said instruction enabling the actuator to orient the wheels of the front steering axle of the follower vehicle, along an angle corresponding to the optimal angle determined in c).

According to an example of an implementation, step a) comprises the sub-steps:
a1) measuring the angle of the rack and pinion of the lead vehicle relative to its position in a straight line,
a2) using a first passage law LP1 to determine the angle of the wheels of the front steering axle of the lead vehicle from the measurement taken in a1),
and step d) comprises the sub-steps:
d1) using a second passage law LP2 to determine the optimal angular position of the rack and pinion of the follower vehicle from the optimal angle determined in c),
d2) delivering by way of the controller of the follower vehicle, an angular position instruction of the rack and pinion to the actuator, said angle instruction corresponding to the optimal angle of the rack and pinion determined in d1).

According to an example of an implementation, the steering control method, to stabilise the train in a yaw, comprises the steps:
measuring the lateral acceleration δᵢ of the vehicle (i),
measuring the lateral acceleration δᵢ₋₁ of the preceding vehicle (i−1),
calculating a stabilised angle instruction γ_{ic} by increasing the optimal angle instruction γ of the rack and pinion of the vehicle (i) of a compensation term according to law: γ_{ic}=γ+G·(δᵢ₋₁−δᵢ), with G a constant.

Advantageously, the connecting pins are integrated to the front and rear hitching members of the lead vehicle and of the follower vehicle(s).

The road train according to the invention has the noteworthy advantage of substantially improving the single-track behaviour of said train, as well as improving the stability of said train in traffic.

The train according to the invention makes it possible to deduce the angular orientation of the wheels of the steering axle corresponding to the particular position of the kinematic subassemblies of the train, namely the vehicles. Insofar as this angular orientation of the wheels is known, depending on the position of the kinematic subassemblies of the train, it is possible to optimally orient said wheels, in real time. The precision of the reverse manoeuvres, particularly during the hitching operation, is also improved.

The front (directional) steering axles of the follower vehicles are thus capable of taking on the lateral forces and thus lower the lateral forces experienced by the rear (non-steering) axle of the preceding vehicle. This makes it possible to significantly reduce the deviation of the train during changes of direction and to substantially improve its stability.

Furthermore, whatever the number of follower vehicles (or trailers) in the train, the driver in the lead vehicle, feels the mass of the train less, by handling the steering wheel. The inertia of the train, which generally is felt via a force return in the steering wheel of the driver, is thus significantly decreased or zero thanks to the driving of the axles of the follower vehicles. The reactivity of the assembly formed by the train is thus improved. The reverse manoeuvres in a straight line or in a turn, constant radii are thus possible for the train.

Another advantage of the train according to the invention resides in the option of using a remote control to drive hitching manoeuvres or depot parking phases, in particular when the follower vehicles have no control station and no steering wheel.

Another noteworthy advantage of the train according to the invention is obtained thanks to the controlled assisted steerings of the follower vehicle(s) by making a specific mechanical stabilisation device useless. The latter can therefore advantageously be replaced by a mechanical system, the only function of which is to recenter the drawbar after a use of the vehicle.

Another noteworthy advantage of the invention resides in the fact that it is effective, even at very low speeds, contrary to systems based on measuring lateral forces in the hitching drawbar and not having the same instantaneous centre of rotation for the entire train and the driving precision of which is less.

### BRIEF DESCRIPTION OF THE FIGURES

Other features and advantages of the present invention will appear more clearly upon reading the description below, made in reference to the accompanying drawings, given as non-limiting examples, wherein:

FIG. 1 is a bottom, perspective view, of an example of an embodiment of a road train according to the invention, comprising a towing vehicle and a follower vehicle before the hitching operation,

FIG. 2 represents the train of FIG. 1, with the hitched vehicles,

FIG. 3 is a top, schematic view, of an example of an embodiment of a road train according to the invention, comprising a towing vehicle and a follower vehicle,

FIG. 4 is a top view of the train of FIG. 1, illustrating an example of angular orientations of the axles of the two vehicles of the train and of the hitching drawbar of the follower vehicle,

FIG. 5 is a schematic illustration of an example of geometric modelling of a kinematic law used to determine the angles of instructions of the steering axles of follower vehicles, in a road train according to the invention, and

FIG. 6 is a top view of the train of FIG. 1, illustrating an example of angular orientations of the axles of two successive vehicles of a train and of the hitching drawbar of the follower vehicle, by illustrating a correction of an angle instruction of the wheels of the follower vehicle thanks to a stabilisation algorithm.

### DETAILED DESCRIPTION

The elements which are structurally and operationally identical, present on several distinct figures, are allocated of one same numerical or alphanumeric reference.

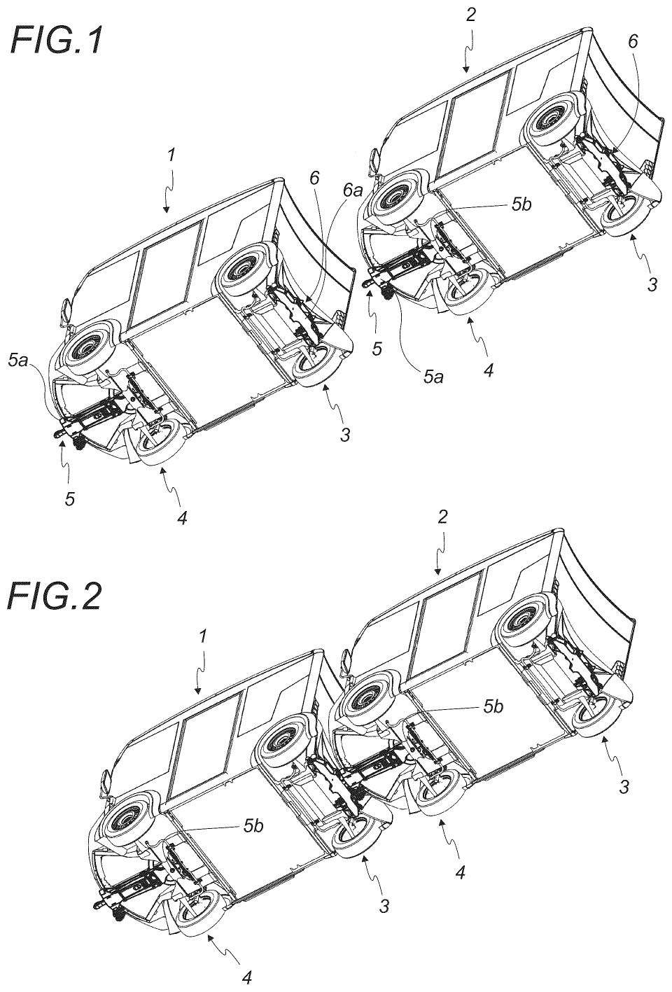

FIG. 1 illustrates an example of an embodiment of vehicles intended to form a motorised road train according to the invention. The latter therefore comprises a lead vehicle 1 and a follower vehicle 2.

According to an example of an embodiment, the follower vehicle 2 is identical to the lead vehicle 1. According to another example of an embodiment, the follower vehicle 2 can have no control station so as to only be used as a trailer hitched to the lead vehicle 1. Each of the vehicles 1 and 2 advantageously comprises a rear axle 3 and a front steering axle 4.

Each of the vehicles 1 and 2 also comprises an electric assisted steering system comprising an electric actuator, for example controllable in angle, acting on the angular orientation of the front steering axle 4 and a controller driving said actuator. Such an actuator forms part of the motorised steering of the vehicle 1 and 2.

The vehicles 1 and 2 also comprise a CAN communication link linking said vehicles of the train to one another, and in particular, the controllers of each of the vehicles to one another.

Each of the vehicles 1 and 2 also comprises front hitching members 5 and rear hitching members 6, so as to be able to hitch the follower vehicle 2 to the lead vehicle 1.

The front, steering members 5 comprise, for example, a hitching drawbar 5a to one single hitching articulation 5b.

According to an example of an embodiment, the hitching articulation 5b is located in a plane transverse to the longitudinal direction of the follower vehicle 2 in question, in the vicinity of and preferably to the rear of the front steering axle 4. A hitch located at the roofs of the vehicles 1 and 2 can thus be considered.

According to an advantageous example of an embodiment, the hitching articulation 5b is located under the vehicles 1 and 2, to the rear of the front steering axle 4.

The hitching drawbar 5a has a projecting free end, which is angularly locked with the rear hitching members 6 of the preceding vehicle once the hitching is performed. The rear hitching members 6 comprise, for example, a hitch clevis 6a. The latter can, for example, pivot about a transverse axis parallel to the rear axle.

The lead vehicle 1 advantageously comprises a control station equipped with a steering wheel to control the angular orientation of the corresponding front steering axle 4.

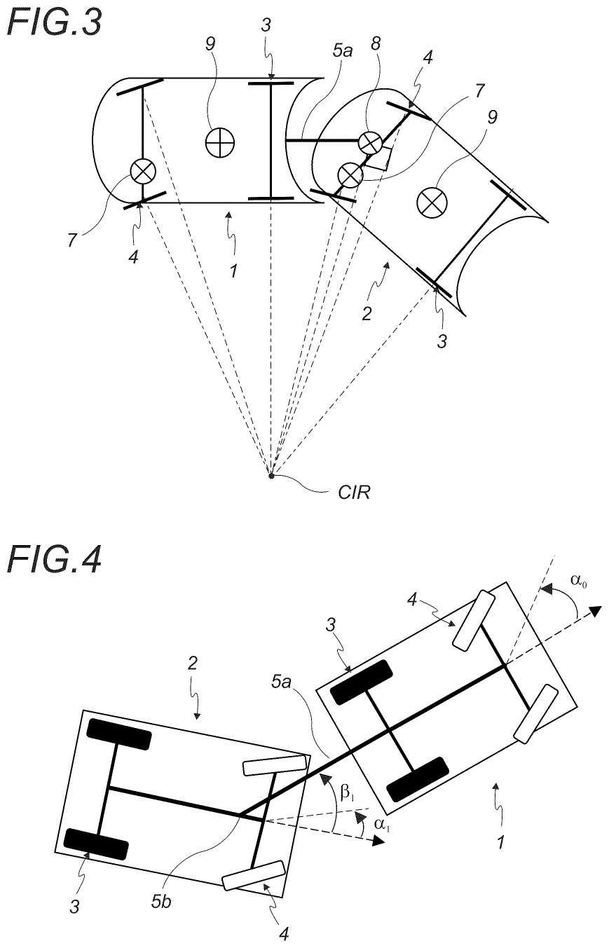

FIGS. 2 and 3 illustrate an example of an embodiment of a motorised road train according to the invention, wherein the follower vehicle 2 is hitched to the lead vehicle 1.

The controller of the follower vehicle 2 is configured to generate angular orientation instructions of the front steering axle 4 and, more specifically, angular orientation instructions of the wheels of said front steering axle 4. The motorised road train according to the invention comprises, for example, a lead vehicle and two, three or four follower vehicles 2.

According to an example of an embodiment, each of the vehicles 1 and 2 is equipped with an orientation sensor making it possible to measure the angle of the wheels of the front steering axle 4. Each of the vehicles 1 and 2 is also equipped with an angular hitching sensor 8 to determine the yaw angular orientation of the hitch relative to the chassis of the vehicle 1 and 2, i.e. the angular orientation of the hitching drawbar 5a relative to the longitudinal axis.

The controller of the or of each follower vehicle 2 advantageously delivers an optimal angle instruction of the wheels and specific to the actuator of the follower vehicle 2 in question. This optimal angle instruction is defined by using a kinematic control law that is a function of the angle of the wheels of the steering axle 4 of the preceding vehicle, and on the yaw angular orientation of the hitch relative to the chassis of the follower vehicle 2 in question. This makes it possible to obtain a single-track train.

According to another example of an embodiment, each of the vehicles 1 and 2 is equipped with an angle sensor of the rack and pinion 7 measuring the angular orientation of its steering wheel relative to a neutral angular position corresponding to a trajectory in a straight line. This makes it possible to determine, by calculation, the angle of the wheels of the corresponding front steering axle 4.

The controller of the or of each follower vehicle 2 is intended to deliver an instruction to the actuator of said follower vehicle 2, to enable it to orient the wheels of its front steering axle 4 along an angle corresponding to the optimal angle that it will have defined beforehand. Such an optimal wheel angle is defined by using a kinematic control law that is a function of the angle of the wheels of the vehicle preceding the follower vehicle 2 in question (i.e. located in front of the follower vehicle 2 in question) and on the angular orientation of the hitch relative to the chassis of said follower vehicle 2 in question.

According to an example of an embodiment, the controller of the or of each follower vehicle 2 is intended to deliver an optimal angle instruction and specific to the actuator of said vehicle.

The angle of the rack and pinion corresponds to the angle of the corresponding steering column, when the vehicle 1, 2 is equipped with such a steering column.

FIG. 3 is a very schematic illustration of an example of an embodiment of a road train according to the invention, wherein are illustrated, more specifically, the front steering axles 4, an angle sensor of the rack and pinion 7, a hitching angle sensor 8, as well as the hitching drawbar 5a. The train therefore, comprises an angular sensor between each kinematic sub-assembly, for determining the relative position of each of said kinematic subassemblies and this, in real time.

FIG. 3 also materialises the theoretical instantaneous centre of rotation CIR of the motorised road train. The instantaneous centre of rotation CIR is identical for all the vehicles of the train, whatever the trajectory, improving the stability of said train.

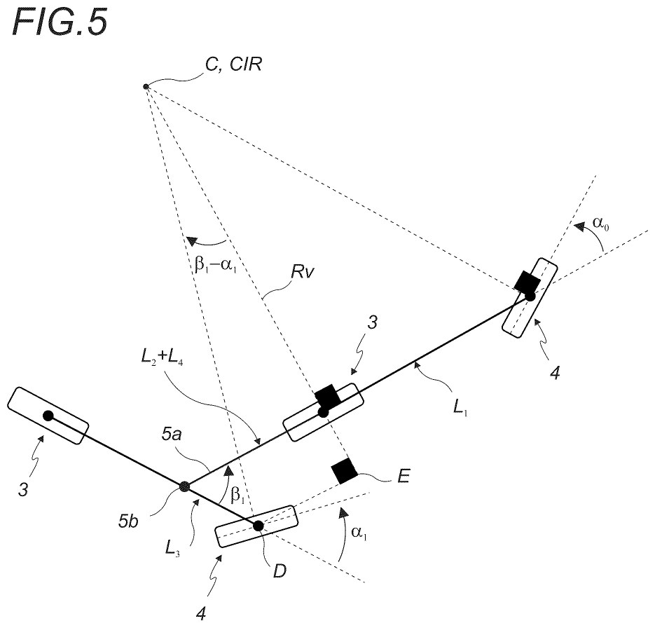

FIG. 4 is a top view of a schematised illustration of angular orientation of the front steering axles 4 and of the hitching drawbar 5a of a follower vehicle 2 in a road train. As an example, the use of a kinematic control law of the steering makes it possible to control with precision, the angle α₁ of the wheels of the front steering axle 4 of a follower vehicle 2 depending on the angle β₁ of its hitching drawbar 5a relative to the longitudinal axis of the chassis and of the angle α₀ of the wheels of the front steering axle 4 of the lead vehicle 1.

The angle α₀ of the wheels of the front steering axle 4 is controlled by an action of the driver on the steering wheel of the lead vehicle 1 or by an instruction generated by an external device, for example, a remote control, acting on the motorised steering actuator of the lead vehicle 1.

The train therefore, implements a method for controlling the orientation of the wheels of the front steering axle 4 of a follower vehicle 2 for a single-track motorised road train, comprising successively the following steps.

According to a step a), the angle of the wheels of the front steering axle 4 is determined, relative to the chassis of the lead vehicle 1.

According to a step b), the hitching angle of the follower vehicle 2 is measured, corresponding to the angular orientation of the hitch relative to the chassis of said follower vehicle 2.

According to a step c), a mathematical law is used, deduced from a geometric modelling of the train, to determine the optimal angle of the wheels of the front steering axle 4 of the follower vehicle 2 from the angle of the wheels determined in a) and of the hitching angle measured in b).

According to a step d), an instruction to the actuator of the motorised steering of said follower vehicle 2 is delivered by way of the controller of the follower vehicle 2, said instruction making it possible for the actuator to orient the wheels of the front steering axle 4 of the follower vehicle 2 along an angle corresponding to the optimal angle determined in c).

According to another example of an embodiment, the angle of the wheels of the lead vehicle 1 is not advantageously measured. The angle of the wheels of the lead vehicle 1 is obtained by way of an angle sensor of the rack and pinion 7 equipping the assisted steering of said lead vehicle 1, which measures the angle of the rack and pinion which is located at the end of the steering column and which drives the steering rack relative to its neutral position, in a straight line.

According to an example of an embodiment, controlling the angle α₁ of the wheels of the follower vehicle 2 is obtained, for example, via the controlling of the angle of the rack and pinion of said follower vehicle 2. Controlling the angle α₁ of the wheels of the follower vehicle 2 is performed by delivering an angle instruction of the rack and pinion to the actuator of the electric motorised steering of said follower vehicle 2.

According to an example of an embodiment, the controller of the follower vehicle 2 is configured to implement a first passage law LP1 “angle of the rack and pinion to wheel angle” which deduces the angle α1 of the wheels from the angle of the rack and pinion γ delivered by the angle sensor of the rack and pinion 7. A second passage law LP2 “wheel angle to angle of the rack and pinion” makes it possible to deduce the angle of the rack and pinion γ dependent on the angle α₁ of the wheels.

The follower vehicle 2, used as a “trailer” function, can therefore easily have no steering wheel and no control station.

According to an example of an implementation, controlling the angle α₁ of the wheels of a follower vehicle 2 is based advantageously on the following operations:
the determination via the first passage law LP1 “angle of the rack and pinion to wheel angle”, of the angle α₀ of the wheels of the lead vehicle 1, from the angle of the steering wheel (angular orientation of the steering wheel) of said lead vehicle 1,
the determination via a geometric model of the tractor-trailer assembly, of the angle 1 of the wheels of the follower vehicle 2 (trailer) from the angle α₀ of the wheels of the lead vehicle (tractor) and the angle β₁ of the hitching drawbar 5a of the follower vehicle 2, and
the determination via the second passage law LP2 “wheel angle to the angle of the rack and pinion” of the angle of the steering wheel of the follower vehicle 2 from the angle α₁ of the wheels of said follower vehicle 2 delivered by the geometric model.

Thus, the angle of the rack and pinion of the follower vehicle 2, obtained from the angle α₁ of the wheels of said follower vehicle 2, is delivered to the actuator driving the angular position of the corresponding pinion of the steering rack.

Thus, according to an example of an implementation of the control method, step a) comprises sub-steps a1) and a2).

According to sub-step a1), the angle of the rack and pinion of the lead vehicle 1 is measured relative to its position in a straight line and according to sub-step a2), a first passage law LP1 is used to determine the angle of the wheels of the front steering axle 4 of the lead vehicle 1 from the measurement taken in a1). According to this same example of an implementation of the control method, step d) comprises sub-steps d1) and d2).

According to sub-step d1), a second passage law LP2 is used to determine the optimal angular position of the rack and pinion of the follower vehicle 2 from the optimal angle determined in c) and according to sub-step d2), an angular position instruction from rack and pinion to the actuator is delivered by way of the controller of the follower vehicle 2, said angle instruction corresponding to the optimal angle of the rack and pinion determined in d1).

FIG. 5 is a schematic illustration of an example of geometric modelling of a kinematic law used to determine the instruction angles of the front steering axle 4 of the follower vehicles 2.

FIG. 5 schematically illustrates an example of geometric modelling based on a first hypothesis consisting of considering that the trajectory of a vehicle during a turn follows Ackermann steering geometry, as well as on a second hypothesis consisting of specifying that the kinematics of the front steering axle 4 of a vehicle is similar to the simplified so-called “bicycle” model.

Such a modelling makes it possible to calculate the instantaneous radius of the turn Rᵥ of the lead vehicle 1 or towing vehicle. Thus,

$${R}_{v} = \frac{{L}_{1}}{tan ( {α}_{0} )} avec {α}_{0} \neq 0 and {α}_{0} \neq \pm π$$

with L₁ being the gap between the front 4 and rear 3 steering axle and α₀ being the angle of the wheels of the front axle 4 relative to the longitudinal axis of the lead vehicle 1.

The calculation of the wheel angle α₁ of the follower vehicle 2 from the triangle DEC identified in FIG. 5 and rectangle in E, is given by:

$$tan ( {β}_{1} - {α}_{1} ) = \frac{DE}{CE} = \frac{( {L}_{2} + {L}_{4} ) - {L}_{3} cos ( {β}_{1} )}{{R}_{v} + {L}_{3} sin ( {β}_{1} )}$$

with β₁ being the angle of the hitching drawbar 5a relative to the longitudinal axis of the follower vehicle 2, L₃ being the distance from the hitching articulation 5b to the front steering axle 4 of the follower vehicle 2, L₂+L₄ being the distance between the hitching articulation 5b to the rear axle 3 of the lead vehicle 1 or of a follower vehicle 2 preceding the follower vehicle in question.

The wheel angle of the follower vehicle 2 is thus given by:

$${α}_{1} = {β}_{1} - ( \frac{( {L}_{2} + {L}_{4} - {L}_{3} cos ( {β}_{1} )}{{R}_{v} + {L}_{3} sin ( {β}_{1} )} )$$

The optimal control instantaneous wheel angle α₁ specific to each follower vehicle 2 is therefore calculated relatively simply, thanks to the law above, corresponding to a mathematical translation of the geometric modelling.

The passage law of wheel angle α to an angle of the corresponding rack and pinion γ, and vice versa, is established simply and in a known manner, depending on the features of the steering rack, as well as the geometry of the front axle, which is also called front train.

By considering the first and second hypothesis indicated above, only the average wheel angle corresponding to the average between the left and right wheel angles of the front steering axle is used.

As an example, the passage law of an angle of the rack and pinion γ to a wheel angle α is given by the polynomial:

$$α = {n}_{1} . γ + {n}_{2} . {γ}^{2} + {n}_{3} . {γ}^{3}$$

and the passage law of wheel angle α to the angle of the rack and pinion α is given by the polynomial:

$$γ = {m}_{1} . α + {m}_{2} . {α}^{2} + {m}_{3} . {α}^{3}$$

The values of constants n₁, n₂, n₃ et m₁, m₂, m₃ are linked to the architecture of the steering assembly comprising the steering column and the rack of the electric assisted steering system.

According to example of operation of the steering control system of a road train comprising a lead vehicle 1 and a follower vehicle 2, each comprising for example, a steering column, the angular orientation of the steering column thus corresponds to the angle of the rack and pinion. The controller of the follower vehicle 2 thus controls the motorised steering of this same follower vehicle 2.

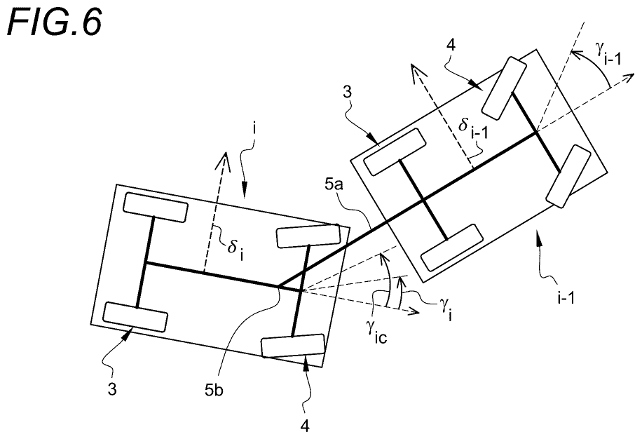

FIG. 6 is a top view, for example of the train of FIG. 1, illustrating an example of angular orientations of the axles of two successive vehicles i−1 and of a train, illustrating a correction of an angle instruction of the wheels of the follower vehicle, thanks to a yaw stabilisation algorithm of said train.

According to an example of an implementation, the control method, comprises steps for measuring the lateral acceleration δᵢ of the vehicle I and for measuring the lateral acceleration δᵢ₋₁ of the preceding vehicle i−1. The vehicles I and i−1 are advantageously each equipped with an inertial unit for measuring the lateral accelerations.

The control method then consists of calculating a stabilised angle instruction γ_{ic} by increasing the optimal angle instruction γ of the rack and pinion of the vehicle I, of a compensation term according to the law:

$${γ}_{ic} = γ + G . ( {δ}_{i - 1} - {δ}_{i} ) ,$$

G being a constant, determined experimentally.

The compensation term G·(δᵢ₋₁−δᵢ) thus makes it possible to correct, dynamically, the optimal angle instruction γ and to deliver the stabilised angle instruction γ_{ic}.

The stabilised angle instruction γ_{ic} is advantageously calculated with a slight time advance, relative to the actual location of the vehicle i. Indeed, the term of angular compensation G·(δᵢ₋₁−δᵢ) integrates lateral acceleration information of the vehicle i−1, which first sees (with a slight advance over time), the future trajectory of the vehicle i. This makes it possible to reduce the undesirable effects of delay generated by assisted steering, said delay generating instability.

Advantageously, the term of angular compensation G·(δᵢ₋₁−δᵢ) is limited in angular amplitude, therefore in steering angle, so as to not disrupt the ideal trajectory of the vehicle I or trailer vehicle.

Thanks to such a complementary stabilisation algorithm, the lateral forces in the drawbar 5a are decreased, and consequently, the instability of the train is decreased. Such a stabilisation algorithm greatly contributes to the stability of the train, in particular when said train comprises three vehicles or more.

It is clear that the present description is not limited to the examples of embodiments or of implementations explicitly described, but also comprises other embodiments or implementations. Thus, a technical feature described, can be replaced by an equivalent technical feature and a step of implementing the control method being able to be replaced by an equivalent step, without moving away from the scope of the present invention, such as defined by the claims.

1. A motorised road train comprising a lead vehicle and at least one hitched follower vehicle, as well as a CAN communication link linking the vehicles of the train, each of the vehicles comprising a rear axle, a front steering axle, an electric steering control system comprising a steering rack, an actuator acting on the angular orientation of the front steering axle and a controller driving the actuator, each of the vehicles also comprising front hitching members and rear hitching members so that the follower vehicle is hitched to the lead vehicle or to another follower vehicle, the controllers of the vehicles being configured to generate angular orientation instructions of the front steering axle of the or of each follower vehicle,
wherein each of the vehicles is equipped both with an orientation sensor for determining the angle of the wheels of the front steering axle and with an angular hitching sensor for determining the yaw angular orientation of the hitch relative to the chassis of the vehicle, the controller of the or of each follower vehicle delivering an optimal angle instruction of the wheels and specific to the actuator of the follower vehicle in question, said optimal angle instruction being defined by using a kinematic control law that is dependent on the angle of the wheels of the steering axle of the preceding vehicle and on the yaw angular orientation of the hitch relative to the chassis of the follower vehicle in question, so as to obtain a single-track train.

2. A motorised road train according to claim 1, wherein the orientation sensor is an angle sensor of a steering rack and pinion, which is located at the output of the steering rack, which measures the angle of the rack and pinion relative to a position of the track and pinion in a straight line, said rack and pinion angle making possible a determination by calculation of the angle of the wheels of the steering axle.

3. A motorised road train according to claim 1, wherein the front hitching members comprise a hitching drawbar to one single hitching articulation, located under the vehicle, and the free end of which is angularly locked with the rear hitching members of the preceding vehicle.

4. A motorised road train according to claim 3, wherein the hitching articulation is located in a plane transverse to the longitudinal direction of the follower vehicle in question, in the vicinity and preferably at the rear of the front steering axle.

5. A motorised road train according to claim 1, wherein the rear hitching members comprise a hitch clevis.

6. A motorised road train according to claim 1, wherein at least the lead vehicle comprises a control station equipped with a steering wheel to manually or remotely control the angular orientation of the front steering axle of said lead vehicle.

7. A motorised road train according to claim 6, further comprising a lead vehicle and at least one follower vehicle, said follower vehicle having no control station.

8. A motorised road train according to claim 1, further comprising a lead vehicle and at least one follower vehicle, said lead and follower vehicles having no control station to constitute an autonomous train.

9. A motorised road train according to claim 1, wherein at least the lead vehicle comprises a control station equipped with a steering wheel to manually or remotely control the angular orientation of the front steering axle of said lead vehicle and wherein the lead vehicle is used as an autonomous train.

10. A motorised road train according to claim 6, further comprising two, three or four follower vehicles identical to the lead vehicle.

11. A motorised road train according to claim 1, wherein the communication link comprises connecting pins to electrically link the hitched vehicles and the electric architecture of which makes it possible to identify the position of each vehicle in the train.

12. A motorised road train according to claim 11, wherein the connecting pins are integrated to the front and rear hitching members of the lead vehicle and of the follower vehicle.

13. A method for controlling the orientation of the wheels of the front steering axle of a follower vehicle for a single-track motorised road train according to claim 1, comprising the steps:
a) determining the angle of the wheels of the front steering axle relative to the chassis of the lead vehicle,
b) measuring the hitching angle of the follower vehicle corresponding to the angular orientation of the hitch relative to the chassis of said follower vehicle,
c) using a mathematical law deduced from a geometric modelling of the train, to determine the optimal angle of the wheels of the front steering axle of the follower vehicle from the angle of the wheels determined in a) and of the hitching angle measured in b), and
d) delivering, by way of the controller of the follower vehicle, an instruction to the actuator of the motorised steering of said follower vehicle, said instruction enabling the actuator to orient the wheels of the front steering axle of the follower vehicle, along an angle corresponding to the optimal angle determined in c).

14. A method according to claim 13, wherein step a) comprises the sub-steps:
a1) measuring the angle of the rack and pinion of the lead vehicle relative to its position in a straight line,
a2) using a first passage law to determine the angle of the wheels of the front steering axle of the lead vehicle from the measurement taken in a1), and in that step d) comprises the sub-steps:
d1) using a second passage law to determine the optimal angular position of the rack and pinion of the follower vehicle from the optimal angle determined in c),
d2) delivering by way of the controller of the follower vehicle, an angular position instruction of the rack and pinion to the actuator, said angle instruction corresponding to the optimal angle of the rack and pinion determined in d1).

15. A method according to claim 13, to stabilise the train in a yaw, further comprising the steps:
measuring the lateral acceleration δᵢ of the vehicle,
measuring the lateral acceleration δᵢ₋₁ of the preceding vehicle (i−1),
calculating a stabilised angle instruction γ_{ic} by increasing the optimal angle instruction γ of the rack and pinion of the vehicle of a compensation term according to law: γ_{ic}=γ+G·(δᵢ₋₁−δᵢ), with G a constant.
